(19) United States
(12) Patent Application Publication
(10) Pub. No.: US 2008/0006561 A1
(43) Pub. Date: Jan. 10, 2008

(54) Dearomatized asphalt

(76) Inventors: Lyle E. Moran, Samia (CA); Larry W. Windsor, Wyoming (CA)

Correspondence Address: ExxonMobil Research & Engineering Company, P.O. Box 900, 1545 Route 22 East, Annandale, NJ, 08801-0900, US

(21) Appl. No.: 11/481,172

(22) Filed: Jul. 5, 2006

(51) Int. Cl. C10C 3/08; B01D 11/04

(52) U.S. Cl. 208/45; 210/634; 210/639

(57) ABSTRACT

This invention relates to a dearomatized asphalt. More particularly, an asphalt is extracted with a aromatic extraction solvent to produce an asphalt-rich phase and a solvent rich phase. The asphalt rich phase is stripped of solvent to produce dearomatized asphalt that has superior properties for paving and roofing applications.

### FIELD OF THE INVENTION

This invention relates to dearomatized asphalt. More particularly, asphalt is extracted with an aromatic extraction solvent to produce an asphalt-rich phase and an aromatics rich phase. The dearomatized asphalt isolated from the asphalt rich phase has superior properties for paving and roofing applications.

### BACKGROUND OF THE INVENTION

Asphalt is a bituminous material resulting from the distillation of crude oil. Typically, asphalt is derived from the bottoms of a vacuum distillation tower and has an atmospheric boiling point of at least 380° C. Because it is hydrophobic and has good adhesiveness and weatherability, asphalt has been used widely as a binder in paving materials and as a coating for roofing shingles.

In order to improve asphalt, polymeric materials have been added to asphalt to enhance its rheological properties, i.e., to improve its creep resistance above about 20° C. Polymer modified asphalts must also have good phase compatibility between the asphalt and polymer, and be storage stable at high temperatures for ease of handling and application. Compatibility between the polymer and asphalt is very important to ensure that the properties of both are transferred to the finished product for good long term performance. Poor storage stability will render the polymer modified asphalt unsuitable for use in paving binder applications, roofing applications, and other industrial specialty products. Accordingly, various methods have been suggested for maintaining storage stability. One method requires continuous mixing of the asphalt/polymer mixture to avoid phase separation. These methods require high shear mixing to obtain physical dispersion of a polyolefin in bitumen. Another method discloses adding one or more dispersants to a polyethylene modified asphalt to avoid phase separation. Another approach is to tailor the composition of the asphalt to ensure compatibility with the polymer used or the polymer is selected to be compatible with the asphalt.

Still another approach is to chemically modify the asphalt. For example, a polymer modified asphalt can be stabilized by the addition of an acid after the polymer has been added to the asphalt. The chemical stabilization process may involve acid addition. An example would be stabilizing mixtures of asphalt and styrenic thermoplastic elastomers (styrene-butadiene-styrene) by adding small amounts of 85% o-phosphoric acid or 36% hydrochloric acid to the asphalt/SBS mixture). Recently, it has been disclosed that the storage stability of acid treated polymer modified asphalts can be improved if the acid is added to the asphalt before the polymer. It is also known that the storage stability of acid treated polymer modified asphalts can be further improved if a branched, rather than a non-branched, polymer is added to the asphalt.

There is market demand by road buyers for paving asphalts that not only meet the Superpave PG Specification but also exceed it due to low temperature climatic conditions. Presently, in order for typically good asphalts to deliver these enhanced Superpave PG properties, expensive and complex modification techniques such as polymer blending and chemical reaction must be undertaken. Polymer modified asphalts typically suffer from an inherent incompatibility between the polymer and hydrocarbon molecular structure requiring special ‘compatibilizing’ techniques (e.g. SBS plus sulfur) and chemical modifications can have asphalt-product deficiencies due to their acidities (e.g. compatibility with some anti-strip additives during paving applications).

However, none of these methods, alone or in combination, disclose that the properties of asphalt can be improved without the addition of additives such as polymers and/or chemical treatment such as the addition of acids.

### SUMMARY OF THE INVENTION

This invention relates to a method for improving neat asphalt properties which comprises: treating an asphalt feed with an aromatics extraction solvent, separating an asphalt rich phase and an aromatics rich phase, and removing solvent from the asphalt rich phase to yield a dearomatized asphalt, wherein the dearomatized asphalt from aromatics extraction has a SUPERPAVE™ Performance Grade of XX-YY where XX represents high temperature stiffness in ° C. and −YY represents low temperature stiffness in minus ° C., provided that one of the following conditions is met:

(a) the high temperature stiffness XX of the dearomatized asphalt is at least 3° C. higher than the high temperature stiffness of the asphalt feed, or

(b) the low temperature stiffness −YY of the dearomatized asphalt is at least 3° C. lower than the low temperature stiffness of the asphalt feed, or

(c) the high temperature stiffness XX of the dearomatized asphalt is higher than the high temperature stiffness of the asphalt feed and the low temperature stiffness −YY of the dearomatized asphalt is lower than the low temperature stiffness of the asphalt feed provided that the sum of the XX and −YY temperatures differences is at least 3° C. over the feed.

Asphalt feeds not meeting the desired SUPERPAVE™ Performance Grade of XX-YY may be upgraded to a higher performance grade by aromatics extraction.

### BRIEF DESCRIPTION OF THE DRAWINGS

FIG. 1 is a model of the SUPERPAVE™ PG matrix.

FIG. 2 is a plot on the SUPERPAVE™ PG matrix of four asphalts versus excellent quality asphalts made from Cold Lake, BCF-22 and Arab Heavy.

FIG. 3 is a graph showing the SUPERPAVE™ PG grading of a dearomatized Cold Lake-NMP extracted crude vs. 100% neat crudes.

FIG. 4 is a Hansen solubility parameter map in which the polar solubility parameter component is plotted against the hydrogen bonding solubility parameter component.

FIG. 5 shows a comparative Superpave plot of the PG properties of the starting material in Example 1 and the dearomatized asphalt (top phase) against those of other, typically good performing, neat PG asphalts.

FIG. 6 shows a comparative Superpave plot of the PG properties of the Cold Lake 80/100, 200/300 and 300/400 penetration grade asphalts after double, NMP-extraction with that of the starting asphalts and of a Cold Lake production reference Superpave curve.

FIG. 7 shows a comparative Superpave plot of the PG properties of the CGSB ‘C’ grade asphalt after double NMP-extraction with that of the starting asphalt and of the Cold Lake production reference Superpave curve.

### DETAILED DESCRIPTION OF THE INVENTION

The asphalt used as feed in this invention may be obtained from a variety of sources including straight-run vacuum residue; mixtures of vacuum residue with diluents such as vacuum tower wash oil, paraffin distillate, aromatic and naphthenic oils, and mixtures thereof; oxidized vacuum residues or oxidized mixtures of vacuum residues and diluent oils; and the like. Other asphaltic materials such as coal tar pitch, rock asphalt, and naturally occurring asphalt may also be used. Typically, the asphalt will have an atmospheric boiling point of at least 380° C., more typically of at least 440° C., and an asphaltene content of between about 5 and about 30 wt. % as determined by ASTM D4124.

Preferred asphalt feeds are those feeds which produce asphalts suitable for paving or roofing applications. Other asphalts feeds include paving or roofing asphalts which are finished asphalts but do not meet industry standards such as the SUPERPAVE™ Specification.

SUPERPAVE™ criteria (as described in the June 1996 edition of the American Association of State and Highway Transportation Officials (AASHTO) Provisional Standards Book and 2003 revised version) can be used to define the Maximum and Minimum Pavement service temperature conditions under which the binder must perform. SUPERPAVE™ is a trademark of the Strategic Highway Research Program (SHRP) and is the term used for the Standard Specification for Performance-Graded Asphalt Binder as per AASHTO Designation: M-320-05. Maximum Pavement Temperature (or “application” or “service” temperature) is the temperature at which the asphalt binder will resist deformation or rutting (also called Rutting Temperature). Minimum Pavement Temperature is the temperature at which the binder will resist cracking. Low temperature properties of asphalt binders are measured by the Bending Beam Rheometer (BBR). According to SUPERPAVE™ criteria, the temperature at which maximum creep stiffness (S) of 300 MPa at 60s loading time is reached, is the Limiting Stiffness Temperature, LST. Minimum Pavement Temperature at which the binder will resist cracking (also called Cracking Temperature) is equal to LST-10° C.

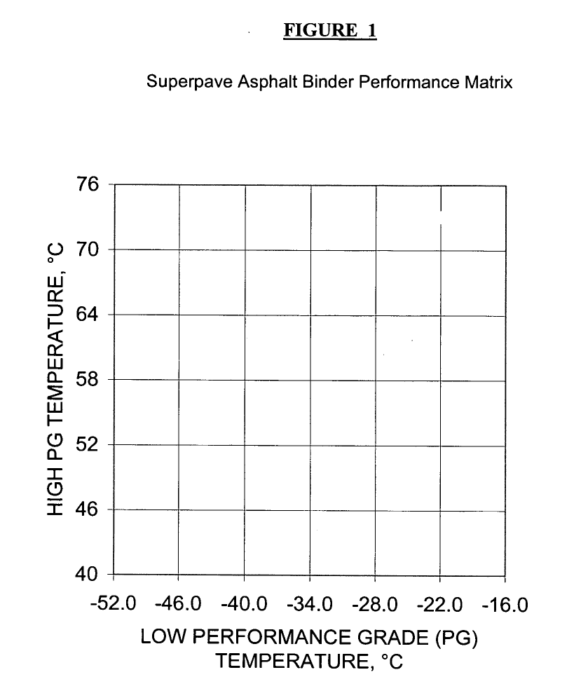

The SUPERPAVE™ binder specification for asphalt paving binder performance establishes the high temperature and low temperature stiffness properties of asphalt. The nomenclature is PG XX-YY which stands for Performance Grade at high temperatures (HT), XX, and at low temperatures (LT), −YY ° C., wherein −YY means a temperature of minus YY° C. Asphalt must resist high summer temperature deformation at temperatures of XX° C. and low winter temperature cracking at temperatures of −YY° C. An example popular grade in Canada is PG 58-28. Each grade of higher or lower temperature differs by 6° C. in both HT and LT. This was established because the stiffness of asphalt doubles about every 6° C. One can plot the performance of asphalt on a SUPERPAVE™ matrix grid. A model SUPERPAVE™ PG matrix is shown in FIG. 1. The vertical axis represents increasing high PG temperature stiffness and the horizontal axis represents decreasing low temperature stiffness towards the left. In the present process, the PG XX-YY is improved by independently moving the XX temperature higher, by independently moving the −YY lower or by conjointly moving the XX temperature higher and the −YY temperature lower. The XX temperature is at least 3° C. higher than the XX temperature of the feed, preferably at least 4° C. higher, more preferably at least 5° C. higher and most preferably at least 6° C. higher than the XX temperature of the feed. The −YY temperature is at least 3° C. lower than the −YY temperature of the feed, preferably at least 4° C. lower, more preferably at least 5° C. lower and most preferably at least 6° C. lower than the −YY temperature of the feed. If the XX and −YY temperature differences conjointly raised and lowered, then the total temperature differences for the joint raising and lowering of the respective XX and −YY temperatures is at 3° C., preferably at least 4° C., more preferably at least 5° C., and most preferably at least 6° C. For example, if one starts with a PG 64-10 pitch and the dearomatization process produces a product asphalt with PG 70-16 which is a suitable grade for a climate like that of California or Florida. For a colder climate like that of Alberta, dearomatization of a PG 58-28 starting asphalt using the present process may change the starting asphalt to PG 58-34 or 64-34. These examples of dearomatized grades demonstrate the invention.

While asphalts can be and typically are further modified by the addition of polymers or copolymers or by air blowing or phosphoric acid treatment, the base asphalt by being inherently a high performance grade asphalt can make do with less of such treatment or such additives or can even dispense totally with such treatment or additives.

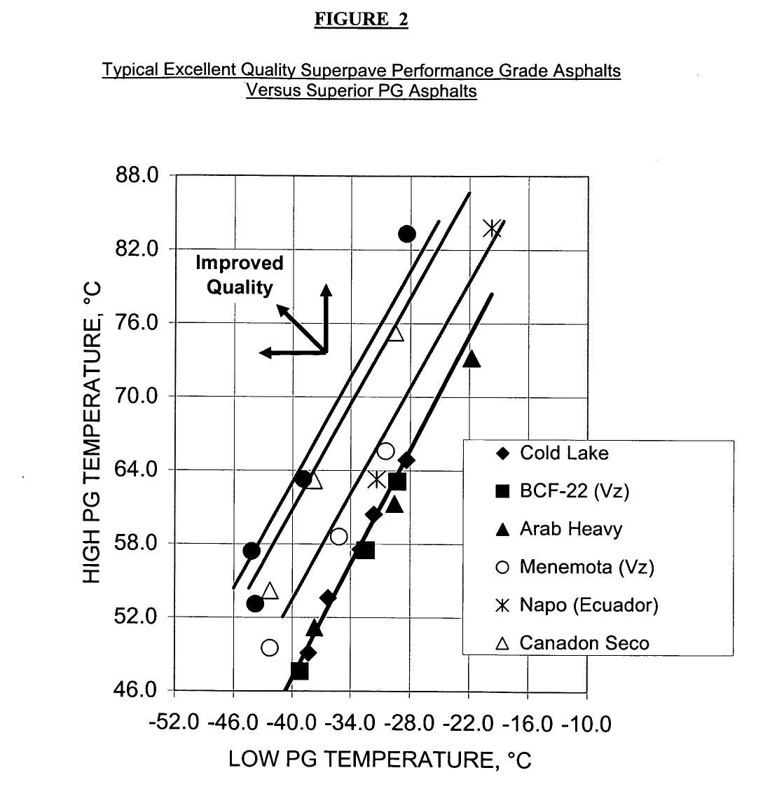

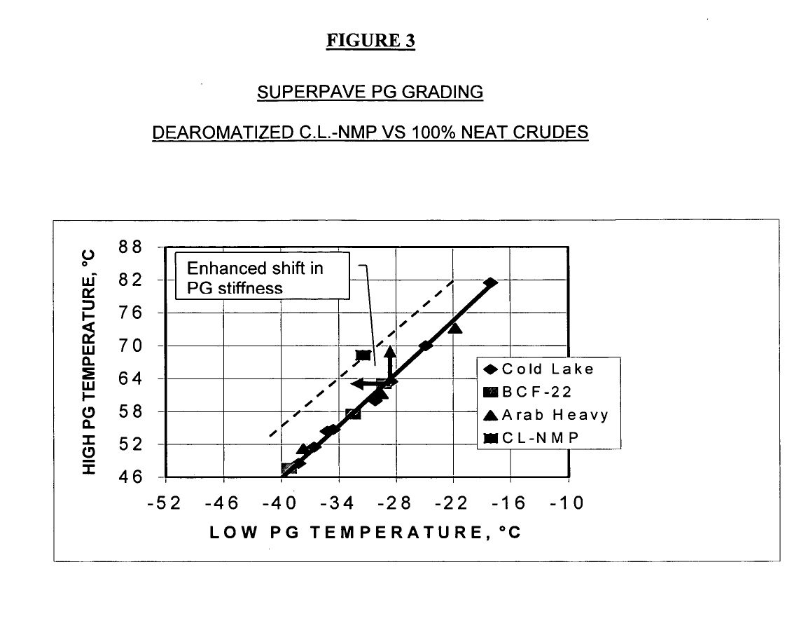

Certain asphalts derived from particular crude sources such as Escalante, Canadon Seco, Menemota and Napo exhibit inherently high performance and are characterized as meeting a SUPERPAVE™ binder specification of PG 58-34 to 64-34. FIG. 2 is a plot of the SUPERPAVE™ PG matrix of these four asphalts versus current excellent quality asphalts made from Cold Lake, BCF-22 and Arab Heavy. In FIG. 2, each crude type has a SUPERPAVE™ curve that is related to high distillation temperature fractions to the upper right and low distillation temperature fractions to the lower left. The curves pass through various PG specification boxes. Asphalt binders from particular crude pass the SUPERPAVE™ specification criteria if they fall within the PG box through which the curves pass. Superior SUPERPAVE™ grade asphalts are those which at least match or fall above the curve for the Menemota crude based asphalt. Directionally poorer asphalt performance is to the lower right. Target exceptional asphalt or enhanced, modified asphalt performance is to the upper left, most preferably in both the HT and LT performance directions. FIG. 3 is a graph showing the SUPERPAVE™ PG grading of a dearomatized Cold Lake-NMP extracted crude vs. 100% neat crudes.

The solvent extraction process for treating asphalt feeds selectively dissolves the aromatic components in an aromatics phase while leaving the more paraffinic components in a paraffin rich phase. Naphthenes are distributed between the aromatics rich and paraffin rich phases. Asphalts isolated from the paraffin rich phase are referred to herein as dearomatized asphalts. By controlling the solvent to asphalt ratio, extraction temperature and method of contacting asphalt to be extracted with solvent, one can control the degree of separation between the aromatics rich and paraffin rich phases. Solvent extraction conditions include a solvent to oil ratio of from 0.5 to 5.0, preferably 1 to 3 and extraction temperatures of from 40 to 120.degree. C., preferably 50 to 100° C.

In carrying out the extraction process, water may be added to the extraction solvent in amounts ranging from 1 to 10 vol. % such that the extraction solvent to the extraction tower contains from 3-10 vol. % water, preferably 4 to 7 vol. % water. The use of added water in the extraction solvent permits the use of lower quality feeds while maximizing the paraffin content of the asphalt rich phase and the 3+ multi-ring compounds content of the aromatics rich phase.

Aromatic extraction solvents are selective to aromatic compounds over paraffinic compounds. Solvents selective to aromatic compounds are solvents containing one or more polar group in their molecules. Examples of such polar groups include hydroxyl, amino, amido, cyano, nitro, carboxyl, ether, and keto. Aromatic extraction solvents containing polar groups include amines, aliphatic polyamines, phenols, glycols, ethers, alcohols, aldehydes, ketones, amides, carboxylic acids, sulfolanes, sulfoxides and pyrrolidones. Examples of aromatic extraction solvents include at least one of n-methyl pyrrolidone (NMP), gamma butyrolactone (GBL), 4-formylmorpholine, dimethyl formamide (DMF) and dimethylacetamide (DMAC).

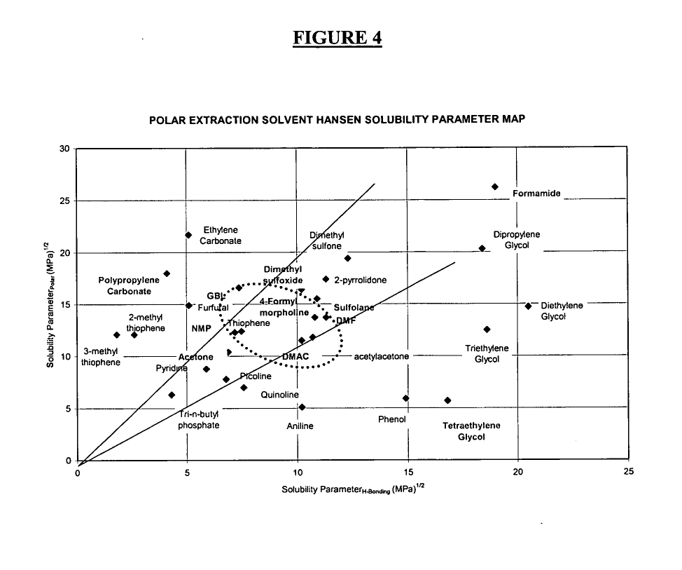

One method of ascertaining which solvents may be candidates for aromatics extracting in the present process is a 2-dimensional Solvent Parameter map. In this method, a map of polar solvent properties vs. hydrogen bonding properties is plotted for various individual solvents. This map, also known as a Hansen solubility parameter, is shown in FIG. 4. As shown in FIG. 4, the polar solubility parameter component is plotted against the hydrogen bonding solubility parameter component where MPa is mega-Pascals. Solubility parameters may be determined by different methods including the Heat of Vaporization, thermal coefficients such as thermal expansion, surface tension, structural analysis, swelling values and intrinsic viscosity. There are standard references for Polar and H-bonding Hansen Solubility Parameters including the CRC Hanbook of Solubility Parameters and Other Cohesion Parameters, Allan F. M. Barton, CRC Press, 1983 and the Handbook of Solvents, George Wypych Editor, ChemTec Publishing, co-published by William Andrew Publishing, 2001. The dotted ellipse shown in FIG. 4 represents an approximate area wherein potential suitable aromatics extraction solvents may be identified. The solubility parameter map should be viewed as a guideline to select solvents for testing as potential solvents. It does not mean that any given solvent falling within or without the dotted ellipse will or will not meet the desired SUPERPAVE™ performance criteria. Only actual testing in the SUPERPAVE™ test will establish this.

In the present process, extraction using aromatics solvent extraction should not be preceded by or in conjunction with solvent extraction using a C₃-C₁₀ straight chain, cyclic and branched chain paraffins. If asphaltic feeds are pre-treated with propane, pentane, heptane or other such solvents, one would be selectively solvent distilling the asphalt (i.e. removing selective asphaltene phases) such that a propane-extracted asphalt that has been dearomatized with aromatics selective solvents such as NMP would not have the excellent asphalt properties of the present invention. In other words, the present process to produce a dearomatized asphalt maintains the excellent asphalt qualities of the asphaltic feed (e.g. Cold Lake asphalt) while selectively removing poor performing resins (e.g. only a small % of all of the aromatic resins) to produce an enhanced asphalt, whereas pre-extraction with a hydrocarbon solvent leads to a product that would be inferior to an enhanced Cold Lake asphalt. Similarly, for a poor performing asphalt that is enhanced by the present dearomatization process, pre-treatment with a hydrocarbon solvent would render the product non-asphaltic.

The solvent extraction process may be done in either the batch mode or continuously. In batch mode, asphalt feed that has been heated to temperatures of about 100 to 150° C. and aromatic extraction solvent are mixed together with or without the addition of water. The solvent/asphalt mixture may be stirred to facilitate contact of asphalt with solvent. Following extraction, the mixture separates into two phases. The asphalt rich phase is separated, stripped of solvent using, e.g., distillation and the dearomatized asphalt recovered. If desired, the extraction process may be repeated for the asphalt rich phase.

In general for a continuous process, feed to the extraction tower is added at the bottom of the tower and extraction and/or water solvent mixture added at the top, and the feed and extraction solvent contacted in counter-current flow. The extraction solvent or solvent containing added water may be injected at different levels if the extraction tower contains multiple trays for solvent extraction.

The present process produces dearomatized neat asphalts with enhanced Superpave PG cement properties thus obviating the need to improve asphalt performance by polymer addition or chemical treatment by acids. Moreover, generally poor performing paving asphalts can be upgraded to good performing asphalts by treatment with aromatic extraction solvents. Finally, roofing asphalts having improved weatherability and low temperature performance may be produced by the process according to the invention.

The invention is further illustrated by the following non-limiting examples.

### EXAMPLE 1

49.2% Strathcona 80/100 C.L. (Cold Lake) Asphalt: ASP-01-050 (Performance Grade (PG) 66-28.1)+50.8% NMP+1% H₂O was extracted for 1 hour at 171-172° C. Two phases formed on sitting post extraction. The top layer was composed of 65.9% asphalt and 34.1% NMP. This phase was separated and stripped in a distillation column yielding 78.9% asphalt. This dearomatized asphalt tested under the Superpave PG Specification system as PG 68.3-31.5. The Bottom liquid layer was separated as 25.5% aromatics and 74.5% NMP. This was stripped. The aromatics recovery was 21.1%.

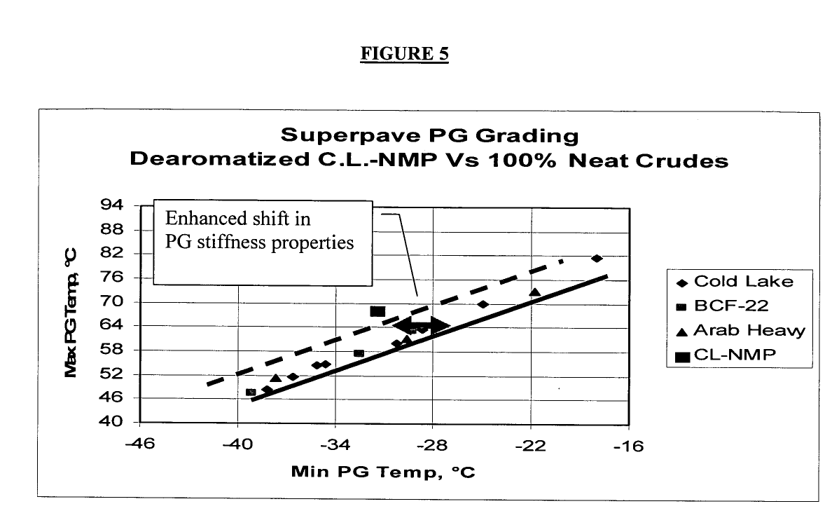

FIG. 5 shows a comparative Superpave plot of the PG properties of the starting material in Example 1 and the dearomatized asphalt (top phase) against those of other, typically good performing, neat PG asphalts. The dotted line is an estimate of how the line would look beyond the one data point.

### EXAMPLE 2

The following standard extraction conditions were implemented for Examples 2 and 3. A double extraction procedure using NMP was conducted. The NMP was placed in the glass flask. Asphalt at 140° C. was poured into the NMP and then mixed with a paddle for 80 strokes in 40 seconds. This mixture was allowed to sit for 30 minutes. Then the bottom phase was drained. More NMP at 30° C. was added to the top phase and then mixed with the paddle for 80 strokes in 40 seconds. This mixture was then allowed to sit for 30 minutes. The bottom phase was drained and then the top phase was drained to yield neat asphalt with improved properties.

In Example 2, Cold Lake 80/100 penetration asphalt was double, NMP-extracted in triplicate, Cold Lake 200/300 penetration asphalt was double, NMP-extracted and Cold Lake 300/400 penetration asphalt was double, NMP-extracted. The top phases were then tested against the Superpave Specification.

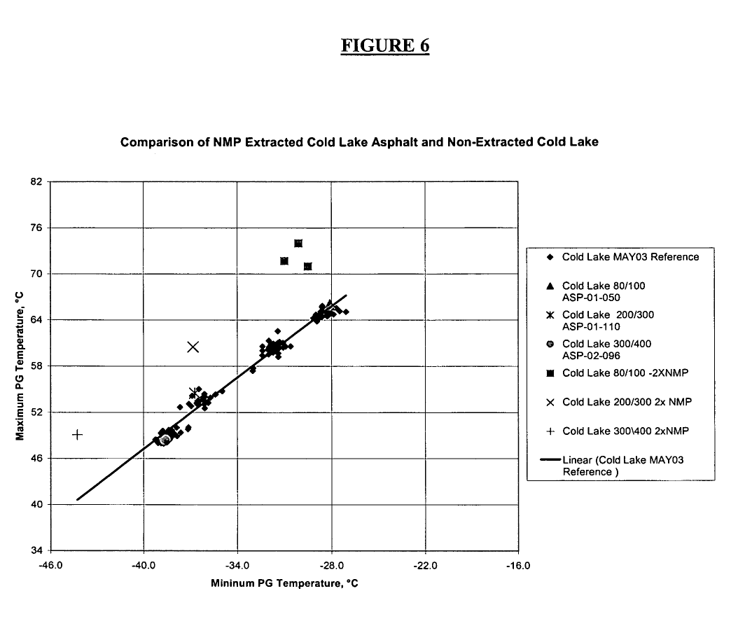

FIG. 6 shows a comparative Superpave plot of the PG properties of the Cold Lake 80/100, 200/300 and 300/400 penetration grade asphalts after double, NMP-extraction with that of the starting asphalts and of a Cold Lake production reference Superpave curve for the period June 2002 to May 2003, referred to as the Cold Lake May 03 Reference. These data demonstrate the invention in that NMP extraction of Cold Lake asphalts unexpectedly produces asphalt that has an enhanced, higher Superpave performance curve.

### EXAMPLE 3

A Canadian General Standards Board (CGSB) ‘C’ grade penetration asphalt was double, NMP-extracted according to the standard extraction conditions given in Example 2. The top phase was then tested against the Superpave Specification.

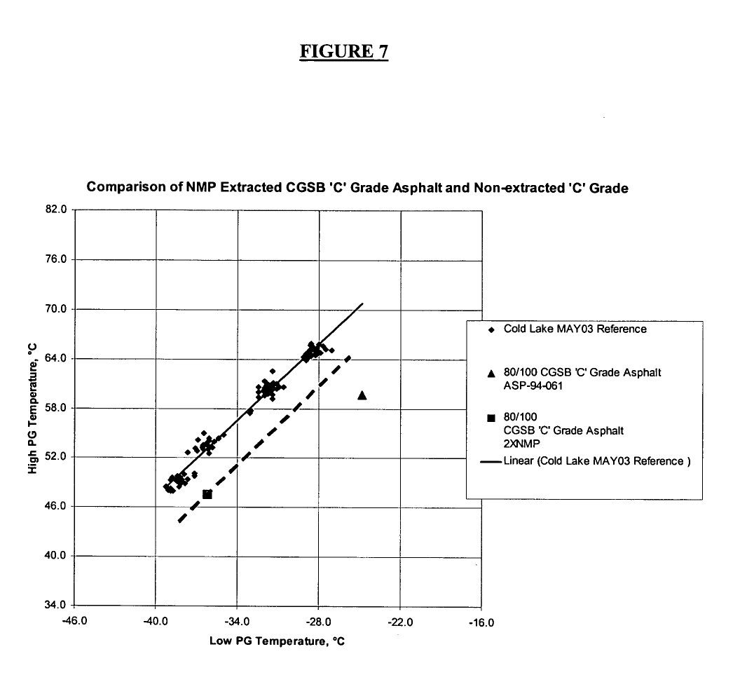

FIG. 7 shows a comparative Superpave plot of the PG properties of the CGSB ‘C’ grade asphalt after double, NMP-extraction with that of the starting asphalt and of the Cold Lake production reference Superpave curve for the period June 2002 to May 2003. These data demonstrate that the invention produces asphalt that has an enhanced, higher Superpave performance curve and that the invention applies to a broad range of asphalt crude sources.

1. A method for improving neat asphalt properties which comprises: treating an asphalt feed with an aromatics extraction solvent, separating an asphalt rich phase and an aromatics rich phase, and removing solvent from the asphalt rich phase to yield a dearomatized asphalt, wherein the dearomatized asphalt from aromatics extraction has a SUPERPAVE™ Performance Grade of XX-YY where XX represents high temperature stiffness in ° C. and −YY represents low temperature stiffness in minus ° C., provided that one of the following conditions is met:
(a) the high temperature stiffness XX of the dearomatized asphalt is at least 3° C. higher than the high temperature stiffness of the asphalt feed, or
(b) the low temperature stiffness −YY of the dearomatized asphalt is at least 3° C. lower than the low temperature stiffness of the asphalt feed, or
(c) the high temperature stiffness XX of the dearomatized asphalt is higher than the high temperature stiffness of the asphalt feed and the low temperature stiffness −YY of the dearomatized asphalt is lower than the low temperature stiffness of the asphalt feed provided that the sum of the XX and −YY temperatures differences is at least 3° C. over the feed.

2. The method of claim 1 wherein the asphalt feeds are those feeds which produce asphalts suitable for paving or roofing applications.

3. The method of claim 1 wherein the asphalts feeds include paving or roofing asphalts which are finished asphalts but do not meet the SUPERPAVE™ Specification.

4. The method of claim 1 wherein XX of the dearomatized asphalt is at least 4° C. higher than the high temperature stiffness of the asphalt feed.

5. The method of claim 1 wherein −YY of the dearomatized asphalt is at least 4° C. lower than the low temperature stiffness of the asphalt feed.

6. The method of claim 1 wherein the high temperature stiffness XX of the dearomatized asphalt is higher than the high temperature stiffness of the asphalt feed and the low temperature stiffness −YY of the dearomatized asphalt is lower than the low temperature stiffness of the asphalt feed provided that the sum of the XX and −YY temperatures differences is at least 4° C. over the feed.

7. The method of claim 1 wherein the aromatics extraction solvent contains one or more polar group in their molecules.

8. The method of claim 7 wherein the aromatics extraction solvent is at least one of n-methyl pyrrolidone (NMP), gamma butyrolactone (GBL), 4-formylmorpholine, dimethyl formamide (DMF) and dimethylacetamide (DMAC).

9. The method of claim 1 wherein water is added to the extraction solvent in amounts ranging from 1 to 10 vol. %.

10. The method of claim 1 wherein the aromatics extraction solvent is not preceded by or used in conjunction with solvent extraction using C₃-C₁₀ straight chain, cyclic and branched chain paraffins.
